(19) United States
(12) Patent Application Publication
(10) Pub. No.: US 2026/0273635 A1
(43) Pub. Date: Sep. 17, 2026

(54) APPARATUS AND METHOD FOR CUTTING STRIPS OF INSULATION FROM PANELS

(71) Applicant: Zachary Edward Patten, Winnebago, MN (US)

(72) Inventor: Zachary Edward Patten, Winnebago, MN (US)

(21) Appl. No.: 19/077,394

(22) Filed: Mar. 12, 2025

(51) Int. Cl. B23D 59/00; B23D 45/10; B23D 47/02; B23D 47/04

(52) U.S. Cl. CPC B23D 59/0064; B23D 45/105; B23D 47/025; B23D 47/047

(57) ABSTRACT

An apparatus for cutting panels of substantially rigid insulation into strips of selected widths includes a guide configured to engage an edge of a panel of substantially rigid insulation. The apparatus includes at least one saw blade spaced from the guide a selected distance corresponding to a selected width of the strips. The apparatus includes a shroud positioned about the at least saw blade wherein the shroud includes an entrance for the sheet of substantially rigid insulation and an exit for the strips of insulation, wherein the shroud comprises a port configured to couple to a hose such that a vacuum can be utilized to remove airborne particulate from within the shroud as the at least one saw blade cuts the insulation.

### BACKGROUND

The present disclosure relates to an apparatus for use to cut panels of substantially rigid insulation into strips. More particularly, the present disclosure relates to an apparatus configured to cut panels of rigid insulation into strips of selected widths.

Many people have steel building constructed due to the long expected useful life, lower costs of construction and relatively lower maintenance costs relative to wooden structures. Many of the steel roofs are constructed of steel panels with raised ribs along the length of the panels. In some instances, edges of the adjacent roof panels include portions of raised ribs that interconnect while forming a seam. The roofs have a tendency to leak along the seams which allows water to enter the interior of the building.

Attempts have been made to use a sealant on the roofs to seal the seams. However, over time the sealants have a tendency of failing which results in the roofs leaking through the seams. In order to overcome the design issues with the metal roofs with raised ribs, the channels between the ribs can be filled to form a substantially flat top surface. A waterproof membrane can then be placed on the upper surface to seal the roof.

A typical material to fill the troughs between the ribs is a substantially rigid insulation material. However, the panels need to be cut into strips to be placed in the troughs between the ribs. One option is to have the panels of insulation precut into selected widths by a supplier. However, utilizing precut strips of insulation increases the cost of a job relative to having the roofer cut the strips of insulation for the panels.

Typically, a circular saw is used to cut the strips of insulation from the panels on site or at the roofer's location. However, the rotational speed of the blade can cause a significant amount of debris to become airborne, which can cause skin, eye and/or respirational irritation.

Additionally, the person using the circular saw can be placed in unnatural and/or awkward positions while cutting the strips of insulation from the panel. The unnatural and/or awkward positions can cause strain and/or injury to the person cutting the strips. Further, there is a risk of being injured by the rotating blade while cutting the strips of insulation from the panels.

Therefore, there is a need for a device that can safely cut strips from panels of insulation, while controlling the airborne debris, whether on site or at a location that is remote from the site.

### SUMMARY

An aspect of the present disclosure includes an apparatus for cutting panels of substantially rigid insulation into strips of selected widths. The apparatus includes a guide configured to engage an edge of a panel of substantially rigid insulation. The apparatus includes at least one saw blade spaced from the guide a selected distance corresponding to a selected width of the strips. The apparatus includes a shroud positioned about the at least saw blade wherein the shroud includes an entrance for the sheet of substantially rigid insulation and an exit for the strips of insulation, wherein the shroud comprises a port configured to couple to a hose such that a vacuum can be utilized to remove airborne particulate from within the shroud as the at least one saw blade cuts the insulation.

Another aspect of the present disclosure relates to a method of cutting strips of insulation having selected widths from a panel of substantially rigid insulation. The method includes moving a panel of substantially rigid insulation relative to an apparatus with a plurality of spaced apart saw blades located a selected distance apart that cuts the panel of insulation of into strips of the selected width by using a guide along an edge of the panel. The method further includes pulling a vacuum through a port on a shroud that provides a shield about the plurality of spaced apart saw blade to collect airborne particulate caused by cutting the panel of insulation into strips.

The present summary is provided only by way of example, and not limitation. Other aspects of the present invention will be appreciated in view of the entirety of the present disclosure, including the entire text, claims and accompanying figures.

### BRIEF DESCRIPTION OF THE DRAWINGS

FIG. 1 is a cutaway view of a panel of a roof with a strip of insulation within a trough.

FIG. 2 is a perspective view of an embodiment of an apparatus cutting a sheet of insulation into strips.

FIG. 3, is a close-up view of an embodiment cutting zone of the apparatus of FIG. 2.

FIG. 4 is another close-up view of another embodiment of a cutting zone of the apparatus of FIG. 2.

FIG. 5 is another embodiment of an apparatus used to cut panels of insulation into strips.

FIG. 6 is an embodiment of the apparatus of FIG. 5 with a shroud removed.

FIG. 7 is another embodiment of the apparatus of FIG. 5 with the shroud removed.

While the above-identified figures set forth one or more embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps and/or components not specifically shown in the drawings.

### DETAILED DESCRIPTION

The present disclosure relates to an apparatus that is configured to cut panels of substantially rigid insulation into strips of selected widths. The width dimension of the strips of insulation are determined based upon the width of troughs between spaced apart ribs on a metal roof and typically range from between about nine inches and about thirteen inches in width. The strips are cut using at least one circular saw blade located a distance from a side edge, and typically a plurality of saw blades, that are spaced apart selected distances to cut strips of insulation with the selected width. The apparatus includes a shroud that shields the user from the saw blades for safety purposes where the shroud includes a vent port for attaching a hose. A vacuum is pulled on the hose to collect airborne particulate in a receptacle caused by the rotating blade cutting the panels of insulation into strips.

In some embodiments, the apparatus is stationary and the panels of insulation are processed through the stationary apparatus to cut the strips of insulation. In other embodiments, the apparatus moves relative to the panels of insulation to cut the strips of insulation.

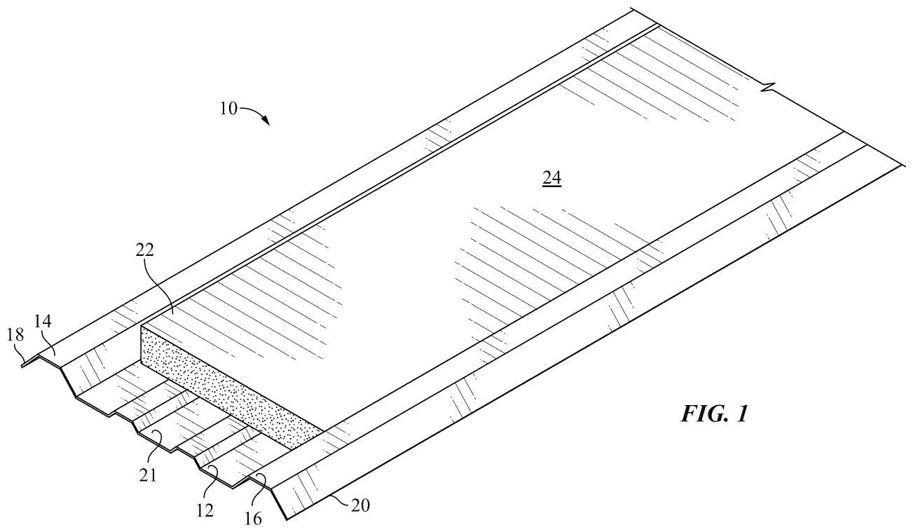

Referring to FIG. 1, a portion of a metal roof is illustrated at 10. The roof 10 includes a plurality of panels, one of which is illustrated at 12. Each panel 12 includes spaced apart raised ribs 14 and 16 proximate edges 18 and 20 where the raised ribs 14 and 16 of adjacent panels 12 overlap and are secured together to form the roof 10. Each panel 12 has a trough 21 between the raised ribs 14 and 16. To aid in sealing the metal roof, a strip of insulation 22 is positioned in the trough 21 so that an upper edge 24 of the strip of insulation 22 substantially aligns with upper surfaces of the raised ribs 14 and 16 to provide a substantially even surface to which a waterproof coating or membrane can be applied to prevent water leakage through the roof 10.

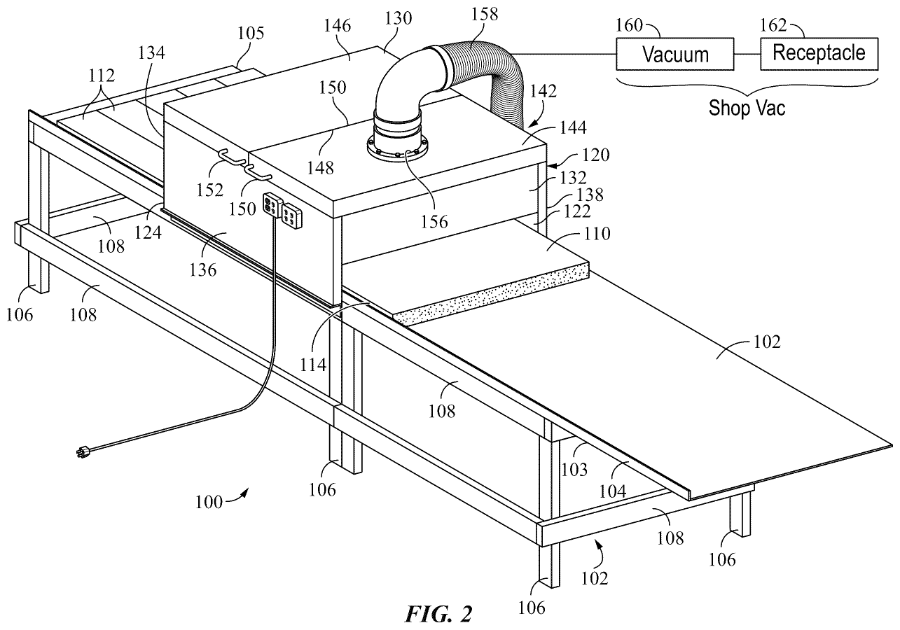

Referring to FIG. 2, a substantially stationary insulation cutting apparatus is illustrated at 100. The insulation cutting apparatus includes a platform 102 that is used to support and guide a panel of insulation 110 through a cutting zone 120 where the panel 110 is cut into one or more strips 112 of selected widths. The platform 102 is supported by a base 102 with a plurality of spaced apart legs 106 that are reinforced with lateral braces 108. The base 102 provides support and rigidity to the platform 102 and the cutting zone 120 such that as the panel of insulation 110 is passed through the cutting zone 120 with manual force, the platform 102 and the cutting zone 120 are substantially static.

The platform 102 extends beyond an entrance 122 and an exit 124 to the cutting zone 120 and provides a support to the panel of insulation 110 as the panel of insulation 110 is processed into strips 112. The platform 102 includes a substantially vertical guide 104 extending upwardly along a lateral edge 103. The substantially vertical guide 104 is configured to engage an edge 114 of the panel of insulation 110 and guide the panel of insulation 110 into, through and beyond the cutting zone 120 as the strips 112 are produced.

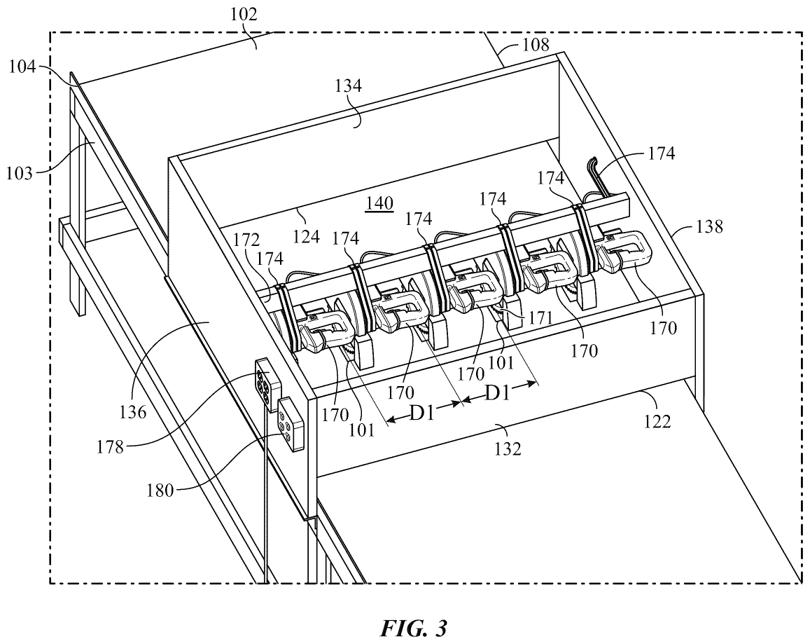

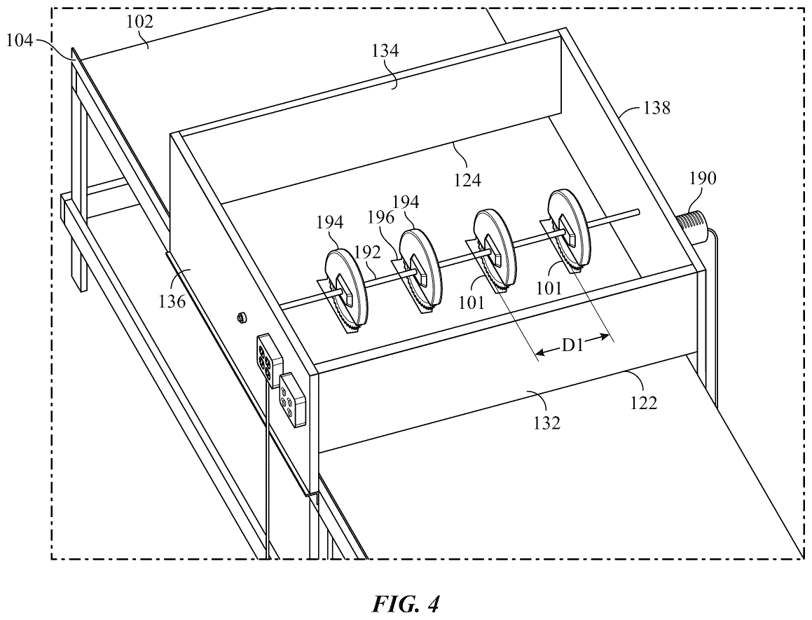

As the panel of insulation 110 is processed in the cutting zone 120, rotating saw blades (as illustrated in FIGS. 3 and 4) engage the panel of insulation 110 at selected intervals based upon the width of the troughs 21 between the raised ribs 14 and 16. While cutting the sheet of insulation, the rotating saw blades cause debris to become airborne which can cause skin, eye and respiratory irritation as well as cause the workers to clean debris from their cloths and hair.

Referring to FIGS. 3-5, the substantially stationary insulating cutting apparatus 100 includes a shroud 130 that covers the rotating saw blades and constricts that the entrance 122 to and exit 124 from the cutting zone 120 with opposing front and back walls 132 and 134 to allow the panel 110 and the strips 112 to pass therethrough while substantially preventing airborne debris from exiting through the entrance 122 and the exit 124. The shroud 130 include left and right side walls 136 and 138 that are secured to the platform 102 proximate the lateral edge 103 and an opposing lateral edge 105 where the left and right side walls 136 and 138 support the front and back walls 132 and 134. The front wall 132, the back wall 134, the left side wall 136 and the right side wall 138 form an interior space 140 sized to accept the rotating saw blades such that the saw blades are free to rotated upon being supplied with power.

The shroud 130 includes a lid 142 that is sized to cover an opening to the interior space 140. In some embodiments, the lid 142 includes a front portion 144 and a back portion 146, where the front and back portions 144 and 146 abut at edges 148 and 150 to prevent airborne debris from exiting the shroud 130. The front and back portions 144 and 146 includes handles 150 and 152 on opposing edges where the handles are used to manipulate the portions 144 and 146 into place on the shroud 140 or to remove the front and back portions 144 and 146 from the shroud 140 to expose the cutting bladed. Utilizing two portions reduces the weight of the lid 142 and increases ability to move the lid 142 with one person. However, a lid 142 constructed of a single piece or more than two pieces are within the scope of the present disclosure.

The front portion 144 includes a port 156 that attaches to a hose 158. The hose 158 is attached to a vacuum 160 with a receptacle 162 that receives airborne particulate that are produced as the panels 110 are sawed into strips 112. The vacuum 160 pulls the particulate into the receptacle 162 and substantially prevents the users from encountering the particulate, either on the skin, eyes or clothes or through respiration.

Referring to FIG. 3, a plurality of spaced apart circular saws 170 are attached to a cross beam 172 spanning a width of the interior space 140 between the left side wall 136 and the right side wall 138. Each of the plurality of spaced apart circular saws 170 is secured with a strap or clamp 174 such that the blades 171 are spaced a selected distance D1 apart based upon the width of the trough in the roof. However, other securing mechanisms are within the scope of the present application. Power cords of the plurality of spaced apart circular saws 170 are secured to the cross beam 172 to prevent the cords from encountering the blades 174 of the plurality of spaced apart circular saws 170. The power cords 174 are directed through an aperture 176 in the right sidewall and are coupled to a power outlet 178 attached to an exterior surface of the shroud 130. The shroud 130 includes a plurality of switches 180, where each switch is wired to provide power to a single circular saw of the plurality of circular saws 170, such that each circular saw is individually controllable.

The platform 102 includes a plurality of slots 101 that are aligned with each of the blades 171 of the plurality of circular saws 170 such that a bottom portion of each blade 171 extends into one of the slots 101. Extending the bottom portion of each blade 171 into each of the slots 101 ensures that the panel of insulation 110 is completely sawed through to from the strips 112. In another embodiment, the platform 102 includes a gap substantially spanning the width of the platform 102 where the bottom portion of each of the blades 171 extends into the gap to ensure the panels 110 are completely sawed into strips 112.

Referring to FIG. 4, another embodiment of the substantially stationary insulation cutting apparatus 100 is illustrated. The apparatus in FIG. 4 is similar to the apparatus in FIG. 3, however instead of utilizing a plurality of circular saws with independently controlled blades, a single motor 190 is utilized to rotationally drive a shaft 192 supported by the left and right side walls 136 and 138, respectively. The motor 190 is exterior to the internal space 140 and therefore is not subject to the airborne particles. A plurality of saw blades 194 are non-rotatably attached to the shaft 192 and secured with a mounting bracket 196 retained to the shaft 192, typically with a set screw. However, other attaching mechanisms are within the scope of the present disclosure including welding, a non-circular cross-sectional shaft, a keyed slot and a clamping member.

The plurality of blades 194 are secured a distance D1 apart on the shaft 192 based upon the width of the troughs on the roof. The platform 102 includes spaced apart slots 101 which accept the bottom portion of each blade 194 to ensure the panel 110 is cut into strips 112.

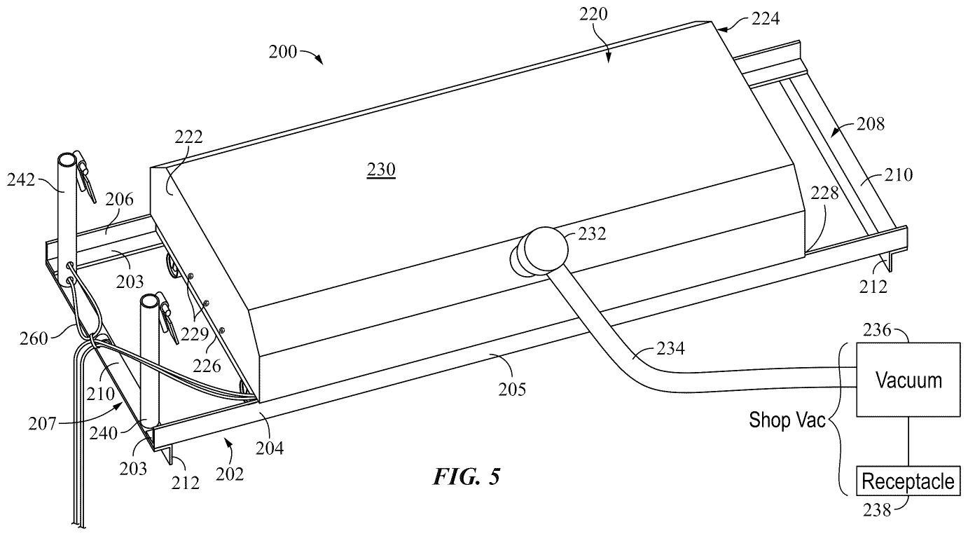

Referring to FIG. 5, a portable and movable insulating cutting apparatus is illustrated at 200. The portable and movable insulating cutting apparatus 200 is configured to be placed on an upper surface one or more panels of insulation and span a width of the one or more panels. The apparatus 200 is then moved across the upper surface along a length of the panel to cut the panels into strips.

The apparatus 200 includes a frame 202 having front and back members 204 and 206 that are attached with left and right side members 207 and 208. The front and back members are typically constructed of “L” cross-section steel members where a bottom portion 203 is substantially flat and the top portion 205 extends upwardly from the bottom portion 203. The left and right side members 207 and 208 are also “L” shaped in cross section where a flat portion 210 is attached to a bottom surface of the bottom portion 203. A downwardly directed portion 212 extends from the flat portion 210 and provides a guide by abutting the portion 212 against a side edge of the top panel(s).

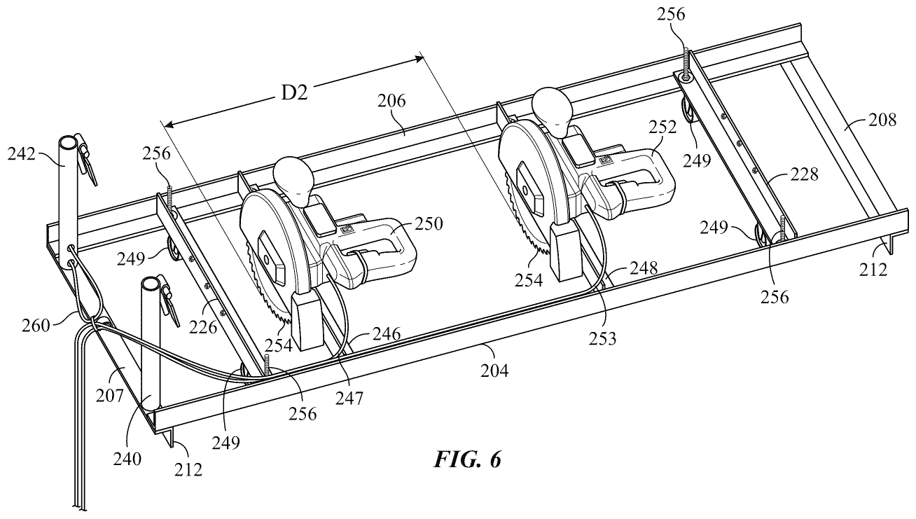

Referring to FIGS. 5 and 6, the apparatus 200 includes a shroud 220 having sidewalls 222 and 224 that attach to internal braces 226 and 228 with a plurality of bolts and nuts 229. The shroud 220 includes a top portion 230 that is supported by the sidewalls 222 and 224 and the front and back member 204 and 206.

The shroud 220 includes a port 232 that is configured to be attached to a hose 234 which is in communication with a vacuum source 236 with a receptacle 238. The vacuum source 236 causes the airborne particulate generated while cutting the insulation panels into strips to be controlled and disposed of in the receptacle 238.

The apparatus 200 includes handles 240 and 242 attached to the left side member 206 where the handles 240 and 242 are configured to be gripped so that manual force can be applied to move the apparatus 200 over the top panel(s) to form strips of insulation having a selected width. Handles can also be optionally attached to the right side member 208 to allow a second person to provide additional manual force, if necessary.

Referring to FIG. 6, the frame 200 includes braces 246 and 248 that attach to the front and back members 204 and 206, typically with a weld. However, other securing devices are within the scope of the present disclosure. The braces 246 and 248 each carry a circular saw 250 and 252 having blades 254 that are spaced a selected distance D2 apart to form a plurality of strips from the panels of insulation.

Caster wheels 249 are attached to the internal braces 226 and 228 and optionally the front and back member 204 and 206. The caster wheels 249 are configured to engage the upper surface of the panel of insulation to roll the apparatus 200 along the length of the panel to cut the strips. A height of the cast wheels 254 can be adjusted using threaded shafts 256 extending through the internal braces 226 and 228 along with nuts or a threaded internal bore in the internal braces 226 and 228.

Power cords 251 and 253 of the circular saws 250 and 252 are retained to the front member 204 to prevent the power cords 251 and 253 from engaging the blades 254. The power cords 251 and 253 engage a loop 260 extending from the handle 242 to retain the power cords 251 and 253 proximate the apparatus 200 as the apparatus 200 is moved over the insulation panel.

While two circular saws 250 and 252 are illustrated and described, the present disclosure can utilize any number of circular saws to cut strips of selected widths from panel.

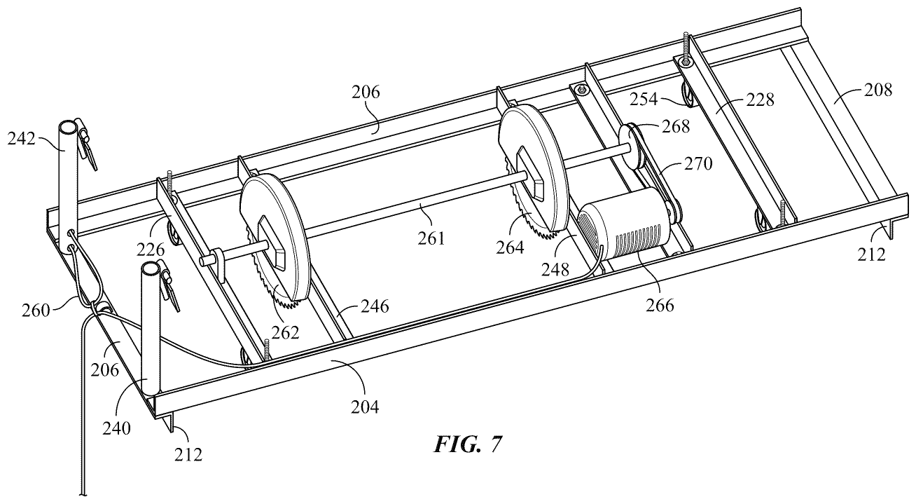

Referring to FIG. 7, another embodiment of the apparatus 200 is illustrated. However, instead of utilizing individually controlled circular saws 250 and 252, the apparatus utilizes a common drive shaft 261 that carries a plurality of circular saw blades 262 and 264 that are non-rotatably attached to the drive shaft 261. The drive shaft is powered by a motor 266 that is coupled to a pully 268 to the drive shaft 261 with a belt 270. However, a gear box can also be utilized to couple the motor 266 with the drive shaft 260.

In operation, a depth of the blades 254, 262, 264 is set below the bottom of the caster wheels 249 at least a thickness of one panel of insulation so that at least one panel is completely cut though to form the strips. In some embodiments a plurality of panels can be cut into strips as the apparatus 200 is moved over the panels along the length.

Although the present invention has been described with reference to preferred embodiments, workers skilled in the art will recognize that changes may be made in form and detail without departing from the spirit and scope of the invention.

1. An apparatus for cutting panels of substantially rigid insulation into strips of selected widths, the apparatus comprising:
a guide configured to engage an edge of a panel of substantially rigid insulation;
at least one saw blade spaced from the guide a selected distance corresponding to a selected width of the strips; and
a shroud positioned about the at least saw blade wherein the shroud includes an entrance for the sheet of substantially rigid insulation and an exit for the strips of insulation, wherein the shroud comprises a port configured to couple to a hose such that a vacuum can be utilized to remove airborne particulate from within the shroud as the at least one saw blade cuts the insulation.

2. The apparatus of claim 1, and further comprising:
a platform with a substantially horizontal surface, wherein the platform extends beyond the entrance and the exit, wherein the guide extends from an edge of the platform, wherein the platform is configured to support the panel of substantially rigid insulation as the panel engages the at least one saw blade and the strips insulation after being cut by the at least one saw blade.

3. The apparatus of claim 2, wherein the platform comprises at least one slot configured to receive a bottom portion of the at least one saw blade.

4. The apparatus of claim 2, and further comprising:
a base supporting the platform at a selected height, wherein the base retains the platform in a substantially static location while the panels of insulation are being cut into strips.

5. The apparatus of claim 1, wherein the at least one saw blade comprises a plurality of saw blade spaced apart at the selected distance such that a plurality of strips is cut as a panel is cut into strips.

6. The apparatus of claim 5, wherein each of the plurality of saw blades are independently powered and independently operable.

7. The apparatus of claim 5, and further comprising:
a drive shaft, wherein each of the plurality of saw blades are coupled to the drive shaft; and
a motor configured to drive the drive shaft.

8. The apparatus of claim 1, and further comprising:
a frame supporting the at least one saw blade and the shroud, wherein the guide extends downwardly from the frame, wherein the frame is configured to move over the panel to cut the panel into strip.

9. The apparatus of claim 8, and further comprising:
a plurality of caster wheels configured to engage and roll over the panel as the apparatus is moved over the panel to cut the strips.

10. The apparatus of claim 8, and further comprising:
at least one handle attached to the frame, wherein the handle is configured to be grasped and used to move the apparatus over the panel with manual force.

11. The apparatus of claim 8, wherein the at least one saw blade comprises a plurality of saw blade spaced apart at the selected distance such that a plurality of strips is cut as a panel is cut into strips.

12. The apparatus of claim 11, wherein each of the plurality of saw blades are independently powered and independently operable.

13. The apparatus of claim 11, and further comprising:
a drive shaft, wherein each of the plurality of saw blades are coupled to the drive shaft; and
a motor configured to drive the drive shaft.

14. A method of cutting strips of insulation having selected widths from a panel of substantially rigid insulation, the method comprising:
moving a panel of substantially rigid insulation relative to an apparatus with a plurality of spaced apart saw blades located a selected distance apart that cuts the panel of insulation of into strips of the selected width by using a guide along an edge of the panel; and
pulling a vacuum through a port on a shroud that provides a shield about the plurality of spaced apart saw blade to collect airborne particulate caused by cutting the panel of insulation into strips.

15. The method of claim 14, wherein the apparatus is stationary and the panel is moved relative to the stationary apparatus to cut the strips.

16. The method of claim 14, wherein the apparatus is moved over the panel of the substantially rigid insulation to cut the strips.

17. The method of claim 16, wherein the apparatus is rolled over the panel of the substantially rigid insulation to cut the strips.

18. The method of claim 14, wherein each of the plurality of spaced apart saw blades are independently powered and controllable.

19. The method of claim 14, wherein the plurality of spaced apart saw blades are driven by a single motor.

20. The method of claim 14, and further comprising collecting the airborne particulate in a receptacle in communication with a vacuum source.
